(19) United States
(12) Patent Application Publication
(10) Pub. No.: US 2004/0182208 A1
(43) Pub. Date: Sep. 23, 2004

(54) Screw mounting device

(76) Inventor: Ming Chieh Hsu, Taipei (TW)

Correspondence Address: HSU Ming Chieh, PO Box 82-144, Taipei, TW

(21) Appl. No.: 10/393,469

(22) Filed: Mar. 21, 2003

(51) Int. Cl. B25B 23/06

(52) U.S. Cl. 81/434

(57) ABSTRACT

A screw mounting device is disclosed. The device has a body, screw strap-pushing module, screw slot seat, stopping body, spring and shaft, characterized in that a through hole is provided on the top portion of the body and the two sides of the through hole are provided upwardly with corresponding protruded block having a cavity hole for the shaft to mount the stopping body and the spring, and the side of the stopping body is provided with a circular top plate having one sided extended to form a conic shape sliding block, and the vertical side face of the top plate is for the urging of one side of the spring, and the other side of the spring urges the inner face of the protruded block, thereby when the screw strap is extended to the sliding hole, the front end touches the conic face of the sliding block, and the sliding block moves the front end of the screw strap to the ring face of the top plate and one side of the screw strap urges the ring face of the top plate, and one end of the spring urges at the inner face of the protruded block and the other end urges the lateral face of the stopping body, thus the screw strap is stopped by the stopping body corresponds to the front end of the screw rod without slanting.

### BACKGROUND OF THE INVENTION

(a) Technical Field of the Invention

The present invention relates to an improve structure of a screw-mounting device, and in particular, a device which can firmly mount a screw without slanting with respect to the position of the screw.

(b) Description of the Prior Art

FIGS. 1 and 2 show a conventional screw-mounting device having a body A, a body tube B and a screw-strap pushing module C. The interior of the body A, near to the top section, is provided with a spring A1 having a front end connected to the slidably fixing seat B1 at the rear end of the tube B. The interior of the seat B1 is a spiral rod A2 having a front end being positioned at an appropriate position of the front of the seat B1 for pushing the screw D2 of the screw-strap D. The tube B is protruded from the front end of the body A and the rear end thereof is connected to the fixing seat B1 which can slide along a passage so that the tube B can be retractable within the body A. However the top face of the tube B to the side is provided with a 90-degree strap-exist hole B2 for the extension of the locked screw strap D. The lower section of the hole B2 is extended with a strap slot B3 having one side being provided with a screw-pushing block B4 which is controlled by the trigger rod C1 to push the strap D2 and the screw D2 is pushed to the tube B for the locking of the spiral rod A2. The disadvantage of the conventional screw-mounting device is that the head of the screw D2 moves forward and may destroy the connected sleeve D1 and the head may be damages. In this case, the damaged screw may be pushed to the strap hole B2. Another disadvantage is that the extended strap D will shake and become slanting and therefore the mounting of the screw is not vertical. When the screw of the strap remains two or three, the length and the weight of the strap will cause the strap D to bend. At this time, the angle of the screw D2 to be mounted will be changed and lost accuracy.

### SUMMARY OF THE INVENTION

Accordingly, it is an object of the present invention to provide a screw-mounting device wherein a through hole is provided on the top portion of the body and the two sides of the through hole are provided upwardly with corresponding protruded block having a cavity hole for the shaft to mount the stopping body and the spring, and the side of the stopping body is provided with a circular top plate having one sided extended to form a conic shape sliding block, and the vertical side face of the top plate is for the urging of one side of the spring, and the other side of the spring urges the inner face of the protruded block, thereby when the screw strap is extended to the sliding hole, the front end touches the conic face of the sliding block, and the sliding block moves the front end of the screw strap to the ring face of the top plate and one side of the screw strap urges the ring face of the top plate, and one end of the spring urges at the inner face of the protruded block and the other end urges the lateral face of the stopping body, thus the screw strap is stopped by the stopping body corresponds to the front end of the screw rod without slanting.

Yet a further object of the present invention is to provide a screw-mounting device, wherein the screw is vertically mounted.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional screw-mounting device.

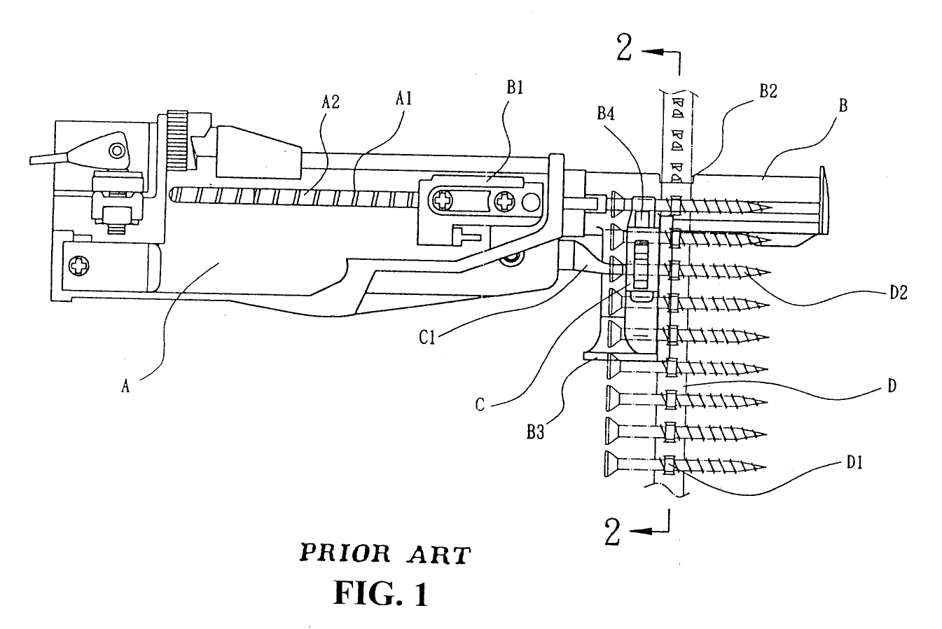

FIG. 2 is a sectional view along line 2-2 of FIG. 1.

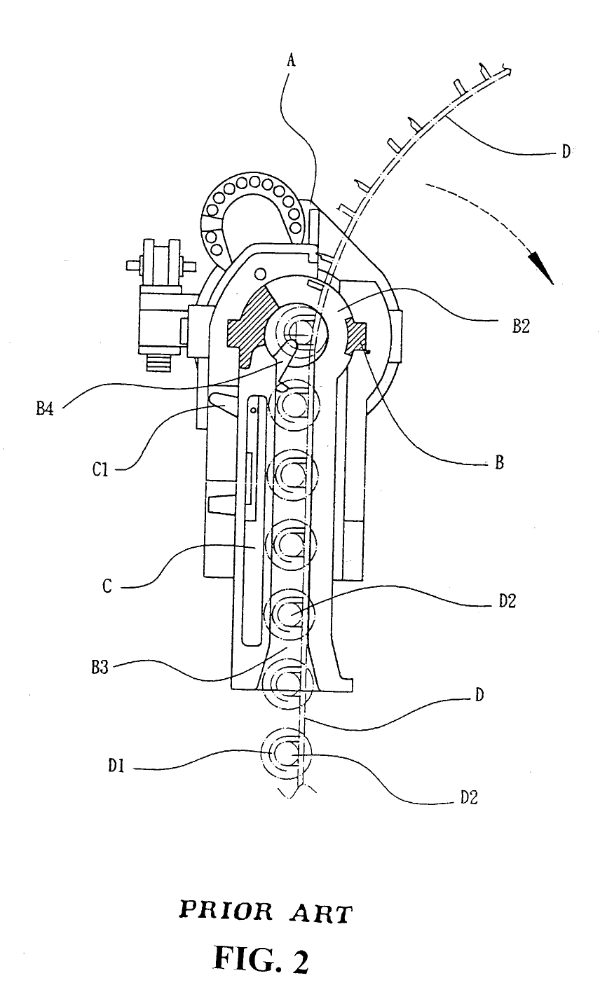

FIG. 3 is a perspective view of a screw-mounting device of the present invention.

FIG. 4 is a schematic view of application of the present invention.

FIG. 5 is a sectional view along line 5-5 of FIG. 4.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

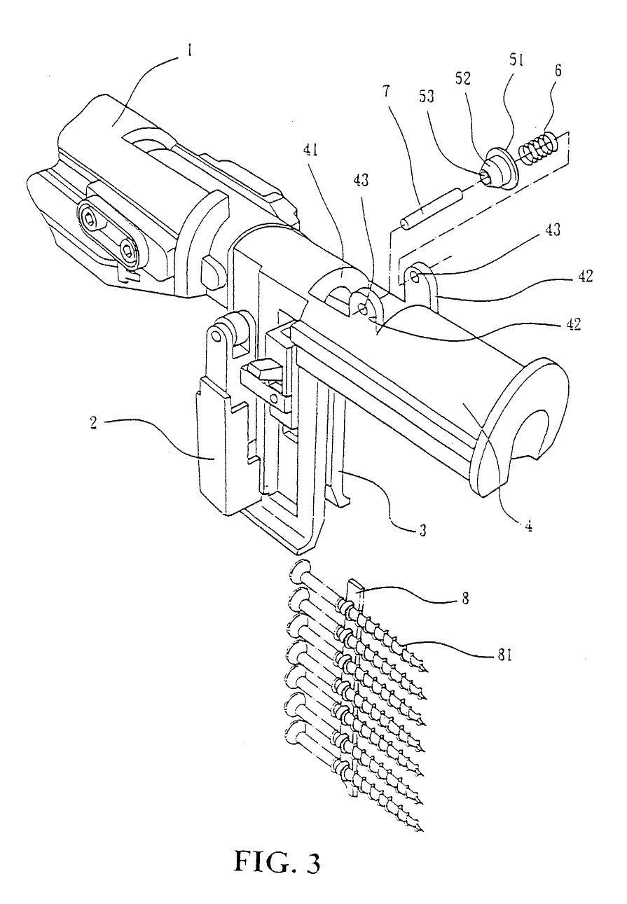

Referring to FIG. 3, there is shown an improved structure of a screw-mounting device having a body 1, a screw-strap pushing module 2, screw slot seat 3, a body tube 4, a stopping body 5, a spring 6 and a shaft. The top face of the body tube 4 is provided with a through hole 41 which is positioned at a position of the slot seat 3 to allow the screw strap 8 to pass through. A through hole is provided on the top portion of the body and the two sides of the through hole are provided upwardly with corresponding protruded block having a cavity hole for the shaft to mount the stopping body and the spring, and the side of the stopping body is provided with a circular top plate having one sided extended to form a conic shape sliding block, and the vertical side face of the top plate is for the urging of one side of the spring, and the other side of the spring urges the inner face of the protruded block, thereby when the screw strap is extended to the sliding hole, the front end touches the conic face of the sliding block, and the sliding block moves the front end of the screw strap to the ring face of the top plate and one side of the screw strap urges the ring face of the top plate, and one end of the spring urges at the inner face of the protruded block and the other end urges the lateral face of the stopping body, thus the screw strap is stopped by the stopping body corresponds to the front end of the screw rod without slanting.

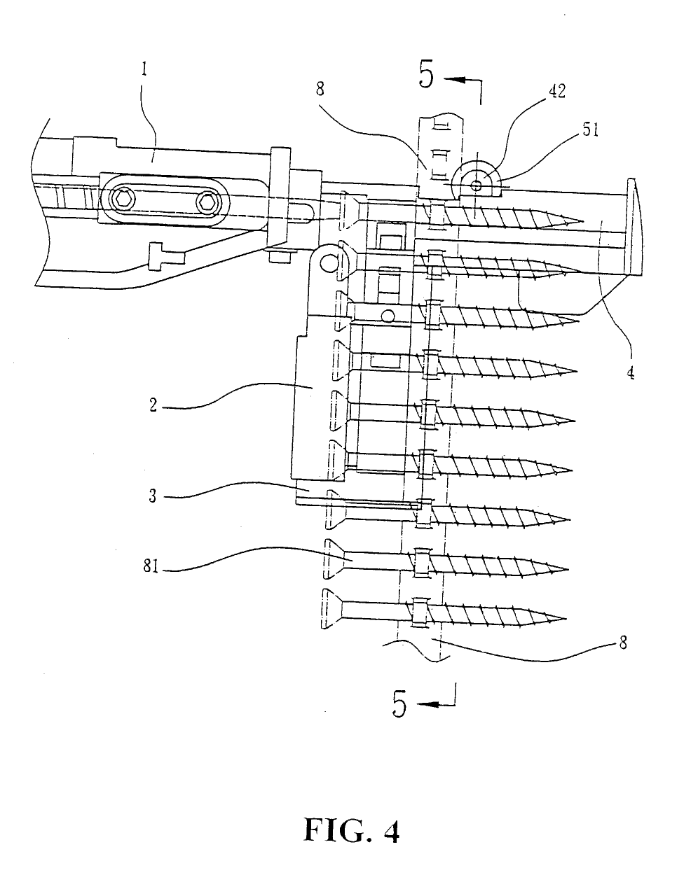

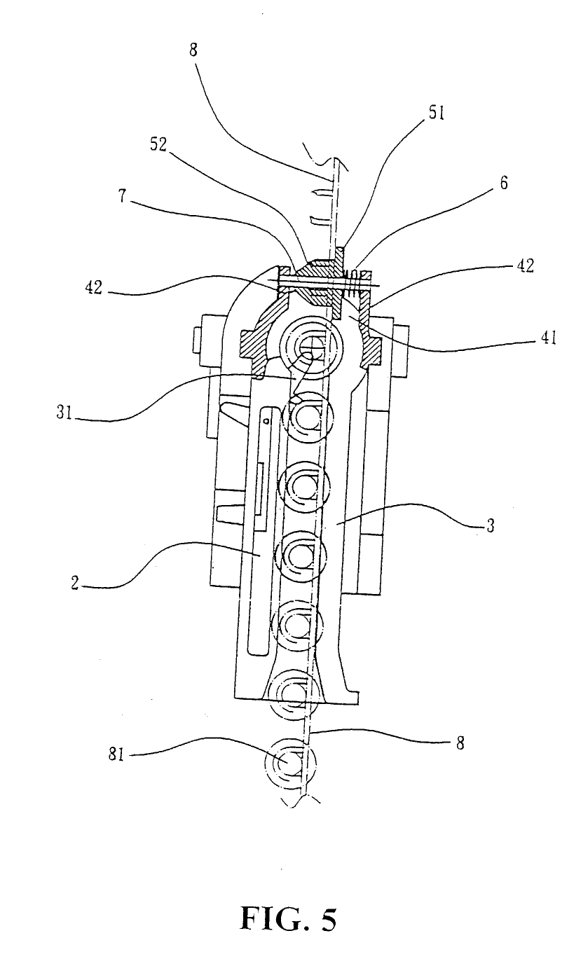

As shown in FIGS. 4 and 5, the spring 6 is mounted at one end of the shaft 7 which passes through the through hole 53 of the stopping body 5. The top plate 51 of the stopping body 5 is perpendicularly urges one end of the spring 6. Next, the two ends of the shaft 7 are respectively mounted to the cavity hole 43, and one end of the spring 6 urges the inner face of the protruded block 42. The vertical face of the top plate 51 being supported by one end of the spring 6, such that the lateral face of the sliding block 52 urges the inner face of the protruded block 42. Thus, the stopping body 5 and the spring 6 can be mounted at the through hole 41 by means of the shaft 7 and positioned between two protruded block 42.

In application, the screw strap 8 is placed at the lower section of the slot seat 3, and the screw 81 is pushed to the center of the body tube 4 for mounting, i.e., the front end of the screw rod 11, then the screw 81 is rotated to screw. After a screw 81 is screwed, the screw strap module 2 causes the screw-pushing block 31 to push another screw 81 to the mounting position. At this instance, the screw strap 8 will be pushed to the through hole 41. When screw strap 8 passes through the through hole 41, the front end of the strap 8 urges the sliding block 52 as a result of the stopping body 5 being positioned between two protruded blocks 42. The sliding block 52 has a conic face and therefore, when the screw strap 8 extends upward to the through hole 41 and touches the sliding block 52, the conic face of the sliding block can move the front end of the strap 8 to the side ring face of the top plate 51, and one side face of the strap 8 urges the ring face of the top plate 51, and the front end of the strap 8 urges the sliding block. The lateral face of the top stopping body 5 is provided with a spring 6 having one end urged the inner face of the protruded block 42. The elasticity of the spring 6 causes the strap 8 to support the ring face of the top plate 51. Thus, when the strap 8 is at the through hole 41, the side face urges the ring face of the top plate 51, and the stopping body 5 urges the strap 8 of the spring 6 such that the strap 8 will not move. When the screw 81 is rotated, the screw 81 causes the strap 8 to move outward. The elastic force of the spring 6 urges the strap 8 inward such that the end face of the sliding block 52 urges the inner face of the protruded block 42, and the stopping block 5 and the strap 8 restore to their original position. Thus, the stopping body 5 is urged with the spring 6 and the strap 8 will move outward and then restore back to its original position, and the screw strap 6 is mounted without slanting.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a screw-mounting device having a body, screw strap-pushing module, screw slot seat, stopping body, spring and shaft, characterized in that a through hole is provided on the top portion of the body and the two sides of the through hole are provided upwardly with corresponding protruded block having a cavity hole for the shaft to mount the stopping body and the spring, and the side of the stopping body is provided with a circular top plate having one sided extended to form a conic shape sliding block, and the vertical side face of the top plate is for the urging of one side of the spring, and the other side of the spring urges the inner face of the protruded block, thereby when the screw strap is extended to the sliding hole, the front end touches the conic face of the sliding block, and the sliding block moves the front end of the screw strap to the ring face of the top plate and one side of the screw strap urges the ring face of the top plate, and one end of the spring urges at the inner face of the protruded block and the other end urges the lateral face of the stopping body, thus the screw strap is stopped by the stopping body corresponds to the front end of the screw rod without slanting.
